(19) United States
(12) Patent Application Publication
(10) Pub. No.: US 2012/0188077 A1
(43) Pub. Date: Jul. 26, 2012

(54) System for controlling a garage door based on a pre-defined schedule

(76) Inventor: David Jess Sawyer, Portland, OR (US)

(21) Appl. No.: 12/929,450

(22) Filed: Jan. 26, 2011

(51) Int. Cl. G08B 21/00; E06B 3/00; G08B 3/00; E05F 15/20

(52) U.S. Cl. 340/540; 49/29; 49/506; 49/13

(57) ABSTRACT

A system for controlling the operation of a garage door is provided. The system controls the closing of the garage door. The system includes a garage door including a motor and a control arm trolley moving along a track. The motor and the control arm trolley control movement of the garage door. The system further includes a switch, which indicates the open or closed status of the garage door. In one embodiment the switch is a magnetic switch connected to the track for performing a mechanical check. Finally, the system includes a control unit including a timer connected in parallel with a push button, IR or RF control. The timer stores a pre-defined schedule for controlling garage door operation. The control unit controls garage door operation based on the mechanical check and the pre-defined schedule.

### BACKGROUND OF THE INVENTION

1. Field of the Invention

The present invention relates to an add-on device to electric garage door openers to provide automated control over the operation of the garage door. In particular, the device and method of the present invention provide automated closing of the garage door.

2. Background of the Invention

Electric garage door openers are widely used in residential housing. For example, new houses typically have one or more garage door openers. These systems provide the convenience of opening and closing the door from your car or from a button mounted somewhere close to a door of the home.

The limitations with known garage door openers are that they require a person to open and close the door. The known systems do not address the problem of closing a garage door if a person forgets to close it or the problem of closing a garage door that did not close due to error.

### SUMMARY OF THE INVENTION

Accordingly, the present invention reflects a device and method of automated control over the operation of a garage door that substantially obviates one or more problems due to the limitations and disadvantages of the related art.

Various embodiments of the present invention provide a system for controlling the operation of a garage door. The system may control closing of the garage door. The system includes a garage door including a motor and a control arm trolley moving along a track. The motor and the control arm trolley control movement of the garage door. The system further includes a switch to indicate the open or closed status of the garage door. The switch may be a magnetic switch connected to the track for performing a mechanical check. This magnetic switch may be placed on one or more garage doors in the system. In another embodiment of the present invention, the switch is a contact switch. Finally, the system includes a control unit including a timer connected in parallel with an input device. The timer stores a pre-defined schedule for controlling garage door operation. The control unit controls the one or more garage door's operation based on the mechanical check and the pre-defined schedule.

In another embodiment of the present invention, a method is provided for controlling operation of the garage door, including controlling the closing of the garage door. The method includes the steps of retrieving a stored schedule from a timer, and at a pre-defined time stored in the schedule, performing a mechanical check on a status of one or more garage doors; if the status of the one or more garage doors is closed, waiting until the next pre-defined time in the schedule. At a later time, if upon retrieving a stored schedule from a timer, performing a mechanical check on the status of the one or more garage doors; if the status of the one or more garage doors is open, the method will send a signal to close the one or more garage doors.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a system for automated control of a garage door;

FIG. 2 is a component view of the add-on device control unit; and

FIG. 3 is a wiring diagram of the add-on device.

### DETAILED DESCRIPTION OF THE INVENTION

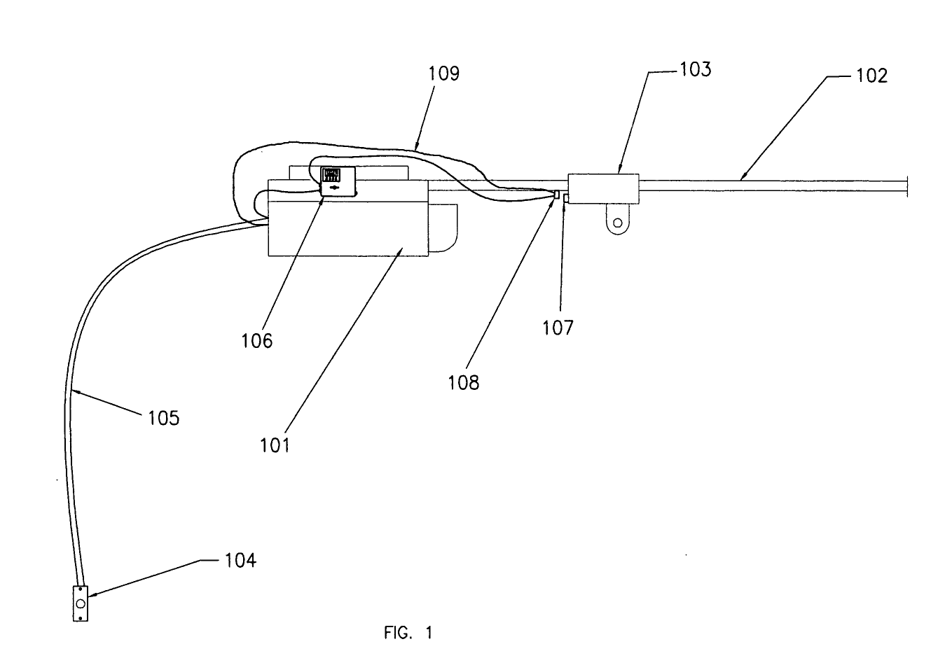

FIG. 1 is a system for automated control of a garage door. FIG. 1 illustrates electric garage door opener 101, track 102, and control arm trolley 103. Garage door opener 101 includes a motor. The motor is capable of receiving wired and wireless control signals for operation. Examples of wireless control include Radio Frequency (RF) and infrared (IR). Control arm trolley 103 moves along track 102 as the garage door (not shown) opens and closes.

FIG. 1 further illustrates push button control 104 and its connection wires 105. In FIG. 1, control unit 106 of an add-on device is attached to the side of garage door opener 101. In the embodiment shown in FIG. 1, a magnet 107 is connected to control arm trolley 103 and a magnetic switch 108 connected to track 102. The magnetic switch 108 may be a normally open reed switch. When control arm trolley 103 is in its fully open position, magnetic switch 108 is located on the track 102 in a position close enough to magnet 107 on control arm trolley 103 so as to detect a magnetic field. Control unit 106 is connected in series with magnetic switch 108. Control unit 106 and magnetic switch 108 are both connected with bell wire 109 in parallel to push button control 104 to the back of the garage door opener 101.

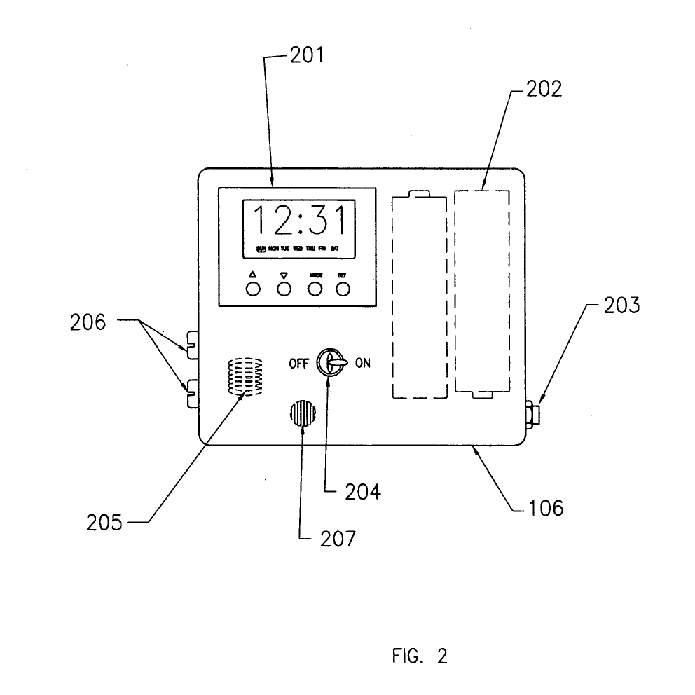

FIG. 2 is the component view of the add-on device control unit 106. Control unit 106 includes timer 201. Timer 201 includes a timing circuit (not shown). Timer 201 may receive and store a schedule through inputs from a user to control operation of the garage door. For example, a user may define two events per twenty-four hour period. In addition, FIG. 2 illustrates battery compartment 202, AC power input plug 203, on/off switch 204, relay 205, wire connection terminals 206, and alarm buzzer 207.

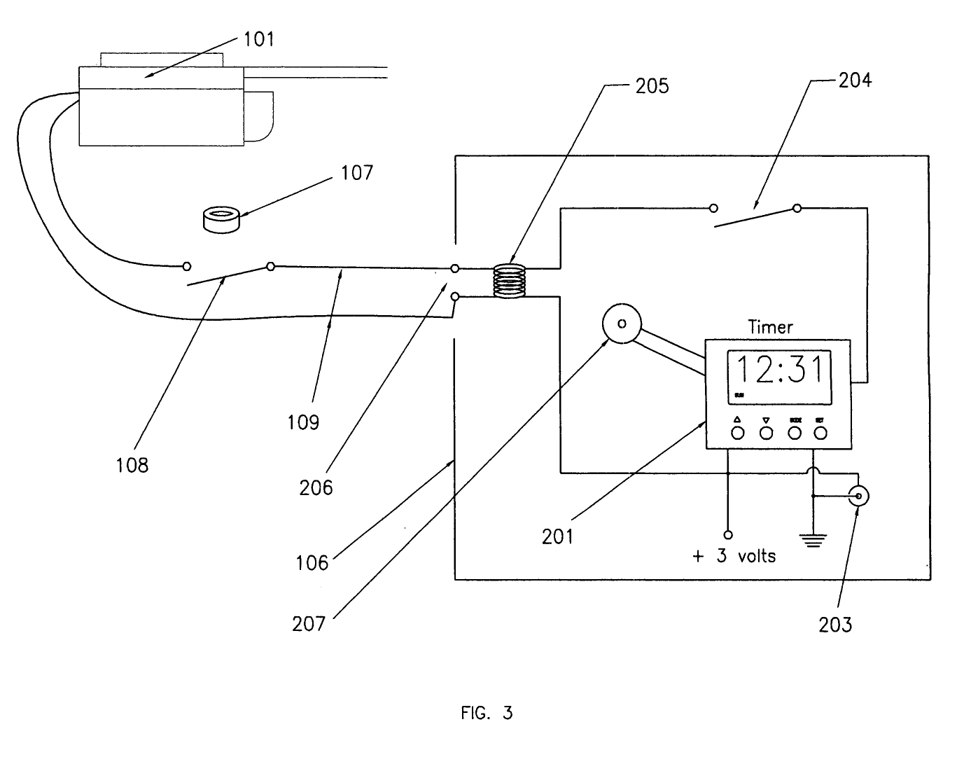

FIG. 3 is a wiring diagram of the add-on device of the present invention. Timer 201 may be powered by batteries (e.g., AAA) or AC adapter input 203. Alarm output from timer 201 controls buzzer 207 and the coil on relay 205. Switch 204 is in the line between the alarm output and relay 205. Switch 204 disables relay 205 when the garage door is to remain in an open position. Timer 201, switch 204 and relay 205 constitute the timer circuit. The relay 205 is also connected to the terminals 206 on the exterior of the control unit 106. Bell wire 109 is used to connect the magnetic switch 108 in line with the garage door opener 101 and the control unit 106. The bell wire 109 connects to the control unit 106 via the terminals 206. The garage door opener 101, magnetic switch 108 and relay 205 constitute the control circuit. The relay 205 isolates the timer circuit from the opener circuit because of different voltages on each circuit. Additional garage door openers 101 may be controlled using one control unit 106 (e.g., if additional garage door openers each have their own unique control circuit and are connected in parallel to the terminals 206).

When magnet 107 is in a position close to magnetic switch 108 so magnetic switch 108 is able to detect a magnetic field, magnetic switch 108 is closed. When relay 205 closes, garage door opener 101 will be activated. When the magnet 107 is away from the magnetic switch 108, the circuit is open and the garage door opener 101 will not be activated. The relay 205 is activated on a schedule controlled by the timer 201, which is set to user-defined periods.

It will be apparent to those skilled in the art that various modifications and variations can be made in the device and method of the present invention without departing from the spirit or scope of the invention. It is intended that the present invention cover the modifications and variations of this invention provided they come within the scope of the appended claims and their equivalents.

What is claimed is:

1. A system comprising:
a garage door including a motor and a control arm trolley moving along a track, the motor and the control arm trolley controlling movement of the garage door;
a switch connected to the track for performing a mechanical check of the control arm trolley;
a control unit including a timer connected in parallel with an input device, the timer storing a pre-defined schedule for controlling garage door operation; and
the control unit controlling garage door operation based on the mechanical check and the pre-defined schedule.

2. The system of claim 1 further comprising a magnet mounted on the control arm trolley.

3. The system of claim 2, wherein the switch is a magnetic switch.

4. The system of claim 3, wherein the magnetic switch performs the mechanical check by sensing the presence of the magnet.

5. The system of claim 3, wherein the magnetic switch is a normally open reed switch.

6. The system of claim 1, wherein the switch is a contact switch.

7. The system of claim 1, wherein the timer receives inputs to adjust the stored pre-defined schedule.

8. The system of claim 1, wherein the input device is selected from the group consisting of a push button, an IR control, and a RF control.

9. The system of claim 1, wherein the input device is configured to manually override the control unit and operate the garage door.

10. The system of claim 1, wherein the pre-defined schedule includes at least two times for at least two events per day.

11. The system of claim 10, wherein the at least two events are selected from the group comprising closing the garage door and opening the garage door.

12. The system of claim 1, wherein the pre-defined schedule is based on a twenty-four-hour period of time.

13. The system of claim 1, wherein the timer is a seven-day timer.

14. The system of claim 1, wherein the timer is a twenty-four hour timer.

15. The system of claim 1, wherein the control unit is configured to open the garage door or close the garage door.

16. The system of claim 1, wherein the control unit is configured to emit an audible alarm to warn about the start of garage door operation.

17. The system of claim 1, wherein the control unit includes an on/off switch to turn off the control unit.

18. The system of claim 3, wherein a bell wire is used to connect the control unit to the magnetic switch and the input device.

19. The system of claim 1, wherein the control unit controls operation of the garage door through wired or wireless communication.

20. The system of claim 1, wherein the control unit controls a plurality of garage doors.

21. A method comprising:
retrieving a stored schedule from a timer;
at a first pre-defined time stored in the schedule, performing a mechanical check on a status of a garage door;
if the status of the garage door is closed, checking the status of the garage door at a second pre-defined time, the second pre-defined time occurring after the first pre-defined time; and
if the status of the garage door is open, sending a signal to close the garage door.
